(19) United States
(12) Patent Application Publication
(10) Pub. No.: US 2008/0024382 A1
(43) Pub. Date: Jan. 31, 2008

(54) Dual Band Antenna Feeding

(76) Inventors: Jesper Uddin, Stockholm (SE); Bjorn Lindmark, Stockholm (SE); Andreas Nordstrom, Stockholm (SE)

Correspondence Address: JACOBSON HOLMAN PLLC, 400 SEVENTH STREET N.W., SUITE 600, WASHINGTON, DC, 20004, US

(21) Appl. No.: 11/791,860

(22) PCT Filed: Oct. 14, 2005
(86) PCT No.: PCT/SE05/01535

§ 371 Date: May 30, 2007

(30) Foreign Application Priority Data
Nov. 30, 2004 (SE) 0402915-3

(51) Int. Cl. H01Q 9/04; H01Q 1/52

(52) U.S. Cl. 343/841

(57) ABSTRACT

The present invention is related to a dual band antenna 1 comprising a number of antenna elements for transmitting and/or receiving radio frequency radiation. The antenna elements are placed above each other, and a shielded feeding means 9 is provided through a first antenna element 2 to a second antenna element 3 for separately feeding the different antenna elements 2, 3.

This is a national stage of PCT/SE2005/001535 filed 14 Oct. 2005 and published in English.

### FIELD OF THE INVENTION

The present invention is related to dual band antennas, of the kind apparent from the preamble of the attached claim 1.

### BACKGROUND OF THE INVENTION

A typical dual band antenna comprises at least one first antenna element including a number of radiating patches, and an associated second antenna element for transmitting and/or receiving radio frequency radiation, and an electrically conductive, substantially planar reflector device. The first and second antenna elements form a combined antenna element on a front side of the reflector device. Microwave power is typically fed from a single feeding network in two separate frequency bands. The microwave power in a first frequency band is being fed via an aperture in the reflector device to a first radiating patch, and the microwave power in a second frequency band is being fed via the aperture in the reflector device, and via a coupling patch and a cross-shaped aperture in the first radiating patch to a second radiating patch. An example of such a prior art dual band antenna is shown in WO02/43183 (Allgon AB).

In a dual band antenna, only a single feeding network is usually needed to feed both antenna elements. However, in some cases it may be necessary to have two separate feeding networks for feeding the antenna elements. For example, in order to obtain an improved, or some specific radiation pattern, it may be necessary to use separate feeding networks.

One such known solution for using separate feedings is shown in EP 1 069 646 A2. The antenna described in said document includes several patches, each patch being fed by feeding means including voltage sources connected to aligned points on the ground plane of a respective patch and probes extending from the point to the patch.

There are a number of drawbacks with the prior art solutions. Firstly, the solution presented in EP 1 069 646 A2 entails a tedious and labour intensive mounting of a bunch of cables, one for each patch being used. This mounting should also be performed such that the probes used are placed in a way so that imaginary lines between diametrically opposed probes are orthogonal. This in order to achieve well isolated dual polarised radiation. Therefore the mounting is rendered even more difficult. Further, each feeding means also includes capacitors, giving several components to be mounted. Further yet, the use of several different cables also gives a difficult and time consuming replacement, should a cable prove to be defect, or break down.

Thus there exists a need for an improved way of providing separate feedings to different antenna elements, wherein the mounting, the maintenance, and also the manufacture, of the antenna is facilitated.

### SUMMARY OF THE INVENTION

An object of the present invention is to provide an antenna construction that overcomes the above mentioned disadvantages. In particular, it is an object of the invention to provide separate feedings in a dual band antenna giving desired radiation patterns in an easily mountable way. In accordance with the invention, the mounting is facilitated, whereby laborious assembling steps are eliminated, and thereby giving a less expensive dual band antenna. Further, a dual band antenna is provided having reliable and secure feeding of the radiating elements of a dual band antenna, giving desired radiation patterns. Further yet, the invention provides a new, inventive and simpler separate feeding of two or more antenna elements in a dual band antenna.

These objects are achieved, according to a first aspect of the invention, by an antenna as defined in the characterizing portion of claim 1.

In accordance with the invention, a dual band antenna is provided, comprising a number of antenna elements for transmitting and/or receiving radio frequency radiation. The antenna elements are placed above each other, and a shielded feeding is provided through a first antenna element to a second antenna element, thereby enabling separate feeding of the different antenna elements.

In accordance with one embodiment of the invention, the shielded feeding is arranged through an aperture area comprised of one or more apertures provided in said first antenna element. Thereby a simple and rather inexpensive, yet reliable solution for feeding the antenna elements separately is provided, which solution renders an easily mountable antenna structure.

In accordance with one embodiment of the invention, the shielded feeding comprises a hollow pipe, through which cables are arranged for feeding the second antenna element. Thereby a rather inexpensive shielding means is provided, that is easy to mount and easy to manufacture.

In accordance with one embodiment of the invention, the hollow pipe comprises several sections having different diameters.

This gives a flexible solution, in which for example the uppermost pipe section may be larger than lower pipe section(s), enabling the designer to hide and protect additional components within the pipe section.

In accordance with one embodiment of the invention, the shielded feeding is conductively connected directly or indirectly to a ground plane. The shielded feeding may be fastened directly to an upper antenna element, or not at all. Thereby means for a flexible design is provided, enabling a designer to customize an antenna to specific needs or demands.

In accordance with one embodiment of the invention, the first antenna element is fed by an aperture in a ground plane. This is the preferred embodiment, and the shielded feeding is preferably arranged through the aperture to an antenna element placed above the first antenna element.

In accordance with one embodiment of the invention, the antenna elements comprise one of a group consisting of: aperture antennas, such as slots, horns or aperture coupled patch antennas, dipole antennas or probe fed antennas. Besides providing a flexible solution, these are well known components, enabling the use of inexpensive and easily exchangeable components.

In accordance with one embodiment of the invention, a first antenna element is adapted to radiate at a low frequency band, and a second antenna element is adapted to radiate at a high frequency band.

In accordance with one embodiment of the invention, the dual band antenna comprises several antenna elements radiating at the same frequency band, and the shielded feeding means is arranged through each of said antenna elements. Thereby a wide band application may be provided.

Further embodiments of the present invention and advantages of it will become clear from the following description, taken in conjunction with the attached drawings.

### BRIEF DESCRIPTION OF THE DRAWINGS

FIG. 1 shows a cross section view over a dual band antenna in accordance with the present invention.

FIGS. 2a-2d show, in different views, an embodiment of an embodiment of the dual band antenna in accordance with the present invention.

FIGS. 3a-b show another embodiment of the present invention.

FIG. 4 shows an exemplary aperture area in a reflector, in a dual band antenna in accordance with the present invention.

FIG. 5 shows exemplary antenna elements of a dual band antenna in accordance with the present invention.

FIGS. 6a-b show another embodiment of the present invention, comprising several antenna elements.

FIG. 7 shows an embodiment of the shielded feeding means having varying diameter.

### DETAILED DESCRIPTION OF PREFERRED EMBODIMENTS

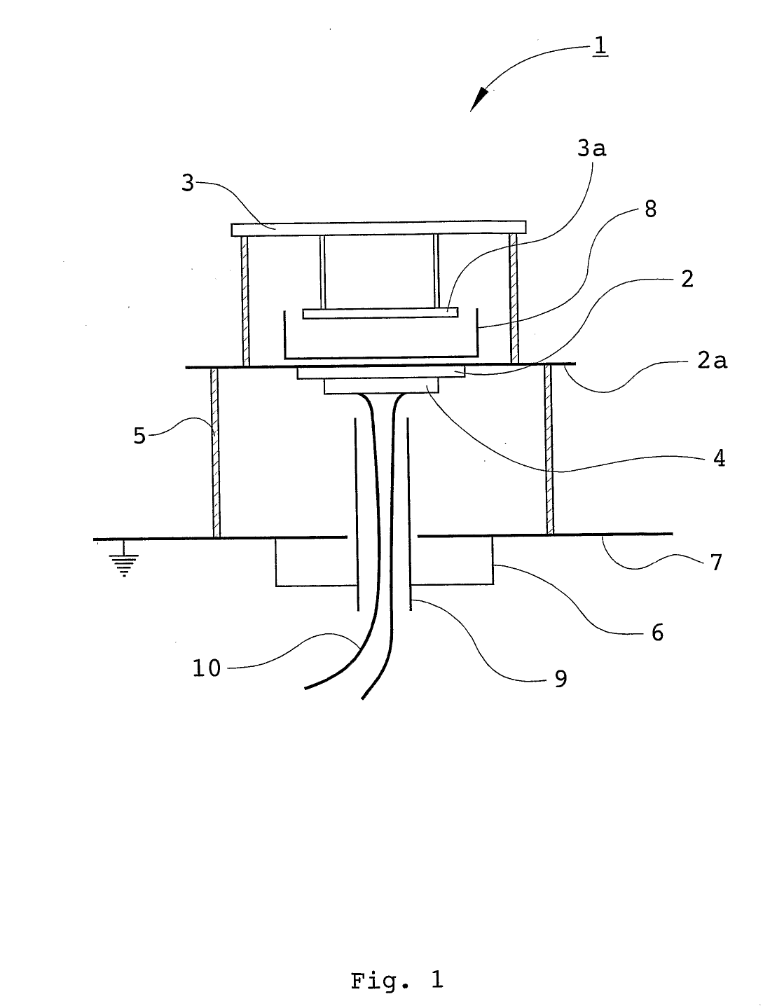

With reference first to FIG. 1, a schematic view of the dual band antenna in accordance with the present invention is shown. A dual band antenna 1 is generally indicated by reference numeral 1. A first antenna element 2 is provided, including radiating elements 2a, such as patches, made of an electrically conducting material for radiating at some frequency. The antenna element 2 is placed, for example by means of distances 5, above a primary reflector 7, whereby the reflector 7 is arranged to reflect radiation from the first antenna element 2. A shielding cage 6 is preferably also provided for preventing back radiation. A second antenna element 3, including radiating elements 3a, is placed above the first antenna element 2, and a secondary reflector 8 is provided for radiating radiation from the second antenna element 3.

The present invention is, in its most general form, based on the idea of using a shielded feeding means 9 through a first antenna element 2 to another antenna element 3 placed above it. The shielded feeding means 9 may preferably be provided by the use of an essentially symmetrical pipe, through which cables 10 or the like are pulled in order to feed the upper antenna element 3. In the schematic view shown in FIG. 1, the shielded feeding means 9 is not connected all the way to the upper antenna element 3, but grounded indirectly to earth by means of the shielding cage 6. Through the shielded feeding means 9, cables 10 are drawn, and connected to a PCB (Printed Circuit Board) 4 fastened underneath the radiating element 2a of the first antenna element 2. The first antenna element 2 comprises apertures for enabling the feeding of the upper antenna element 3.

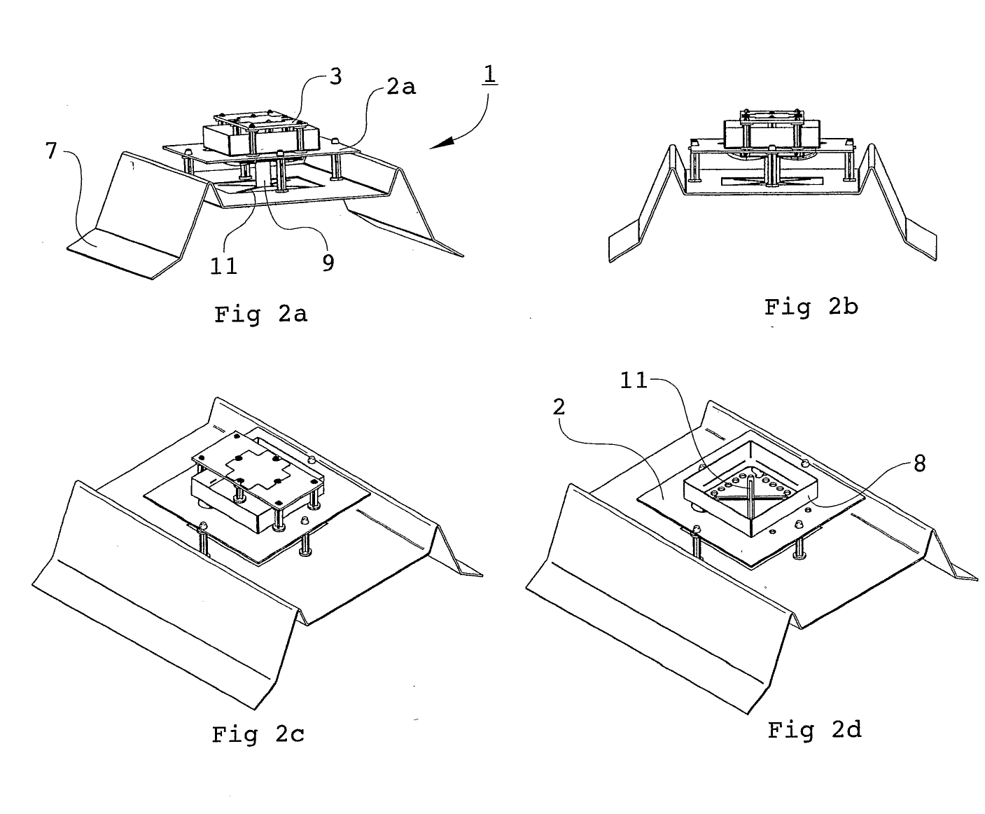

In accordance with the invention thus, and with reference now to FIG. 2a-c, the invention described in connection with FIG. 1, is shown more in detail. The shielded feeding means 9 is provided through an aperture 11 in the first antenna element 2, for enabling a separate feeding of the second antenna element 3, as was described above. The shielded feeding means 9 may for example comprise a hollow pipe, made of any suitable electrically conductive material, such as a metal. The hollow pipe is arranged through the middle of this lower first antenna element 2, for example through apertures 6 in a primary reflector 7, and grounded, in this embodiment indirectly to earth, by means of the shielding cage 6 attached to the primary reflector 7. The primary reflector 7 is arranged to reflect radiation from the first antenna element 2, but care should in some cases be taken in regards of its affect on the radiation characteristics of the one or more upper antenna elements 3. Through the hollow pipe, cables 10 may now be drawn to a feeding network 4 arranged for feeding the second antenna element 3 with power. In FIG. 2d, the upper antenna element 3 has been removed in order to illustrate the apertures 11 in the secondary reflector 8.

In the embodiment shown in FIGS. 2a-2d, the shielded feeding means 9, for example a hollow pipe, is arranged through an aperture in the first antenna element 2, and leaving some space between the feeding network 4 and the shielded feeding means 9. This enables an easier mounting of the cables 10 to be connected to the feeding network 4 (e.g. a PCB fastened underneath the second antenna element 3) for feeding the second antenna element 3.

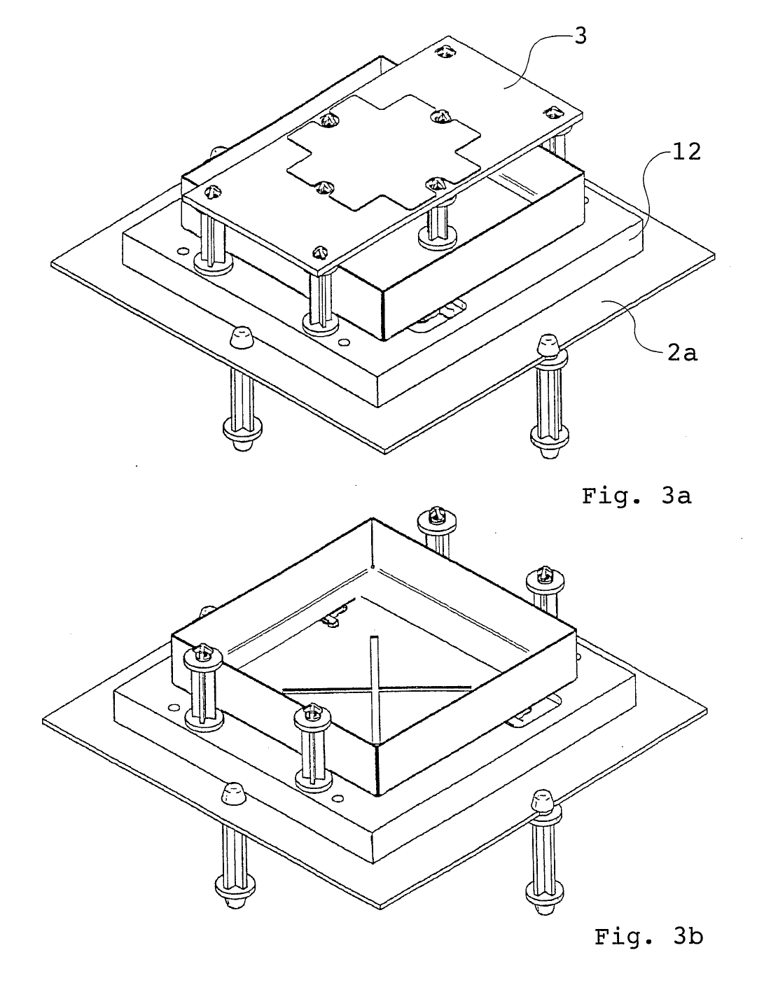

In another embodiment, shown in FIGS. 3a-3b, the shielded feeding means 9 is connected to the second antenna element 3, and the feeding network 4 feeding the second antenna element 3 is placed on top of the first antenna element 2. In this embodiment a shielding cage 12 is therefore provided underneath the reflector 8 of the second antenna element 3. This shielding cage 12 is necessary in cases where the shielded feeding means 9 is connected to the upper antenna element 3, the shielding cage 12 providing the indirect grounding in the embodiment shown in FIGS. 3a-3b. The shielding cage 12 may enclose the required feeding network, such as for example a PCB (not shown) fastened in it, and any other preferred components.

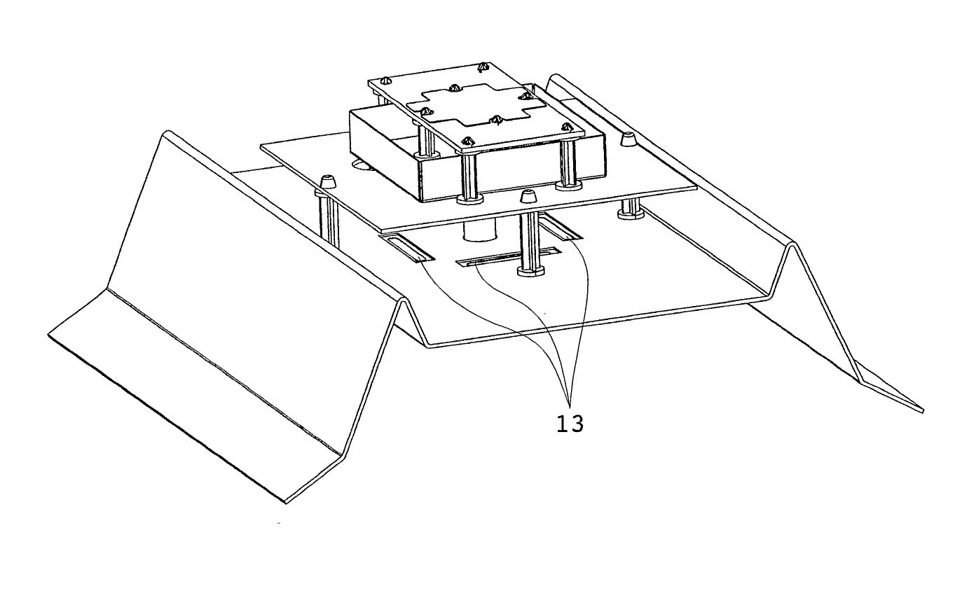

In FIG. 4 an alternative embodiment of the present invention is shown. Instead of a cross-shaped aperture consisting of perpendicular slots, as in the embodiment shown in FIGS. 1 and 2a-2d, an aperture area 13 is provided in the primary reflector 7. The aperture area 13 may consist of one or more straight slot apertures, or elliptic apertures. This provides an antenna that may easily be produced for its specific, intended use, and thus flexible design means.

In another embodiment, for example in the embodiment shown in FIG. 4, the shielded feeding means 9 is connected directly to the grounded primary reflector 7, not indirectly via a shielding cage 5 as in the embodiment described above. The shielded feeding means 9 may for example be soldered to the primary reflector 7.

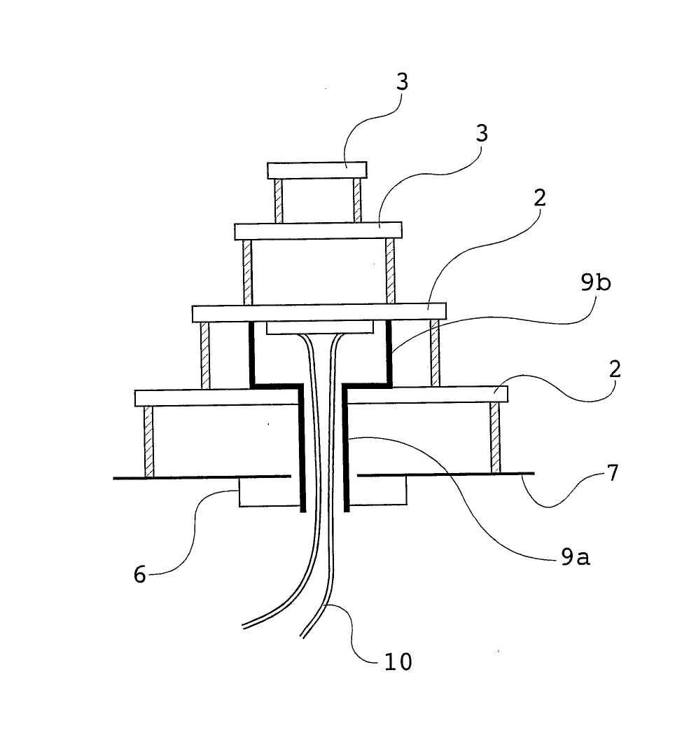

The smaller the hollow pipe is made, the better, a first requirement being that there is enough room for the provision of the feeding means (for example cables) to the second antenna element 3. The second (i.e. the upper) antenna element 3 may thereby be fed by means of cables drawn through the hollow pipe. A second requirement is that it should be possible to ground the hollow pipe, directly or indirectly. However, it is possible to use a hollow pipe having varying diameter, i.e. the pipe could comprise several pipe sections having different diameters. An advantage thereby obtained would be the possibility to use a pipe section having a larger diameter for the uppermost antenna element(s). FIG. 7 illustrates such a shielded feeding means comprising a hollow pipe with a varying diameter. The shielded feeding means 9 has two pipe sections in the illustrated embodiment, having a first section 9a with one diameter, and a second section 9b having another diameter. In FIG. 7, two antenna elements for radiation in a first (preferably lower) frequency band is shown, and also two upper antenna elements for radiation in a second (preferably higher) frequency band. In a pipe section with a larger diameter, additional desired or required components may be placed, whereby the components may be protected and hidden.

For achieving the best possible performance of the antenna, the feeding should be as symmetric as possible. If the second (upper) antenna element 3 is providing only vertically polarization, a single cable is enough, whereby the hollow pipe may be omitted, and the single cable be drawn directly. This is because a coaxial cable is symmetric per se, and shielded. If dual polarization is required or desired, and thus necessitating two cables, the shielded hollow pipe is necessary for providing symmetry.

In accordance with another embodiment, the shielded feeding means may be provided by other means as well (i.e. not by means of the hollow pipe). The shielded feeding means 9 could be achieved for example in the form of wrapping conductors in a metal foil or the like. This would give a very thin and small shielded feeding, which is advantageous in some applications.

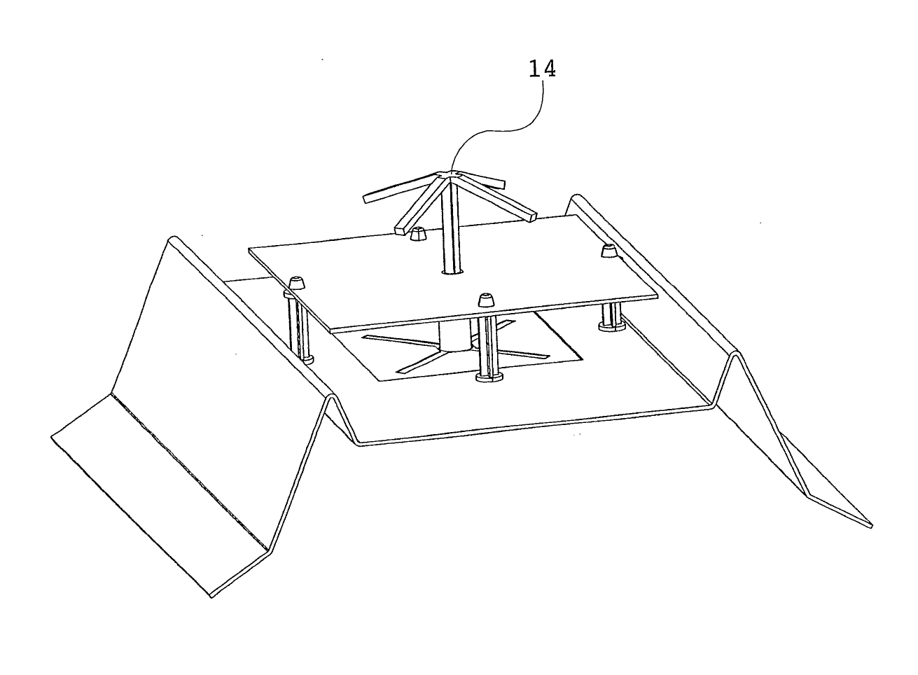

In FIG. 5 yet an alternative embodiment of the present invention is shown, comprising a dipole antenna 14 for the high frequency band radiation instead of a patch antenna 3a, as in FIGS. 1 and 2a-2d. It is realized that the invention is not limited to the use of dipoles 14 or patch antennas 3, but any suitable radiation means may be utilized, for example probe fed antenna elements. The low frequency band (lower antenna element) is preferably always aperture fed, while the uppermost high frequency band is thus optionally fed, as exemplified above.

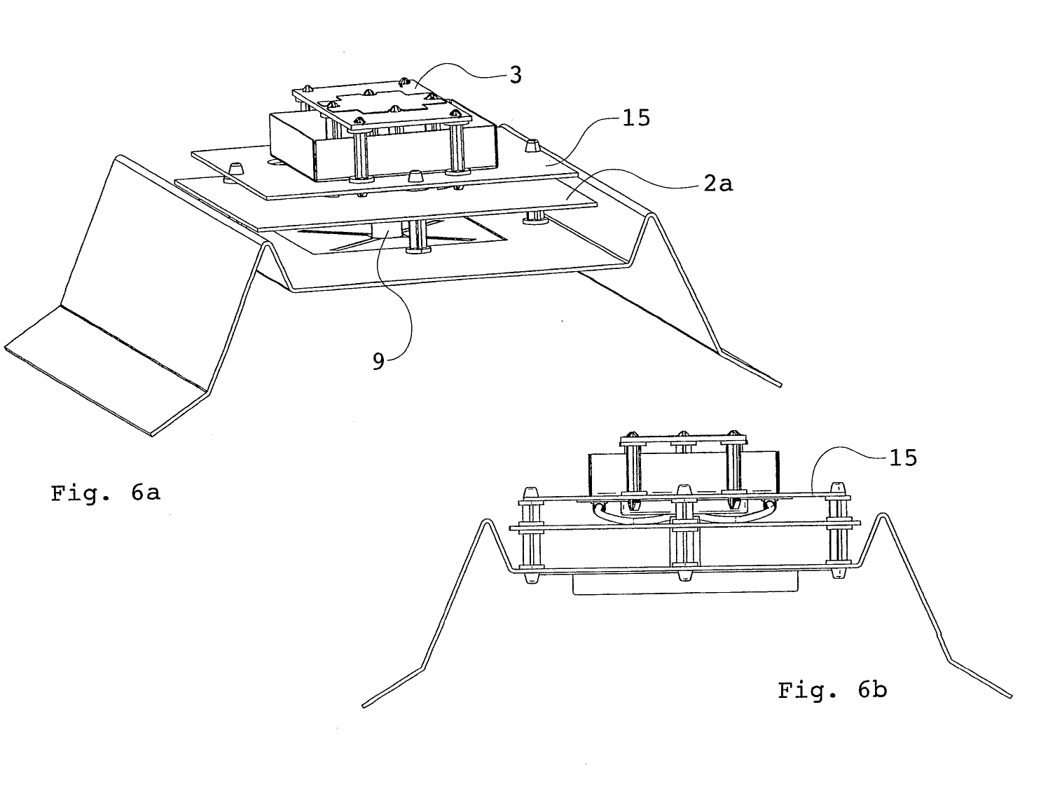

FIG. 6a-b show yet another embodiment of the present invention. In this embodiment an additional antenna element 15 is provided. This may function for example in order to provide wide-band characteristics of the low-band antenna. It is realized that further antenna elements may be stacked above each other, through which the shielded feeding means 9 is arranged. It is also understood that each frequency band could be widened by arranging several antenna elements for each band, whereby the shielded feeding means 9 is arranged through suitable antenna elements for separately feeding the uppermost antenna elements.

In accordance with the invention, an arrangement containing several dual band antennas in accordance with the invention may also be provided.

In summary, the present invention provides a new, inventive way of achieving separate feeding of the different antenna elements in a dual band antenna, by means of a shielded feeding means. Although the present invention has been shown and described by specific embodiments, many alterations and modifications are possible, as would be obvious to a person skilled in the art.

1: A dual band antenna comprising a number of antenna elements for transmitting and/or receiving radio frequency radiation, said antenna elements being placed above each other, characterised in that a shielded feeding means is provided through a first antenna element to a second antenna element for separately feeding the different antenna elements.

2: The dual band antenna as claimed in claim 1, wherein said shielded feeding means is arranged through an aperture area comprising one or more apertures provided in said first antenna element.

3: The dual band antenna as claimed in claim 1, wherein said shielded feeding means comprises a hollow pipe, through which cables are arranged for feeding said second antenna element.

4: The dual band antenna as claimed in claim 3, wherein the hollow pipe comprises several sections having different diameters.

5: The dual band antenna as claimed in claim 1, wherein said shielded feeding means is conductively connected directly to a ground plane.

6: The dual band antenna as claimed in claim 5, wherein said shielded feeding means is conductively connected directly to a grounded primary reflector.

7: The dual band antenna as claimed in claim 1, wherein said shielded feeding means is conductively connected indirectly to a grounded primary reflector by means of a shielding cage.

8: The dual band antenna as claimed in claim 1, wherein the first antenna element is fed by an aperture in a ground plane.

9: The dual band antenna as claimed in claim 1, wherein said antenna elements comprise one of a group consisting of: aperture antennas, such as slots, horns or aperture coupled patch antennas, dipole antennas or probe fed antennas.

10: The dual band antenna as claimed claim 1, wherein a first antenna element is adapted to radiate at a low frequency band, and a second antenna element is adapted to radiate at a high frequency band.

11: The dual band antenna as claimed in claim 1, wherein the dual band antenna comprises several antenna elements and whereby the shielded feeding means 9 is arranged through each of said antenna elements.
